(19) United States
(12) Patent Application Publication
(10) Pub. No.: US 2006/0165922 A1
(43) Pub. Date: Jul. 27, 2006

(54) Thermal transfer recording medium

(75) Inventors: Hideo Toyoda, Tokyo (JP); Kojiro Kan, Sodegaura-shi (JP); Seiichi Ikeyama, Sodegaura-shi (JP); Hideo Nakamura, Tokyo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MITSUI CHEMICALS, INC., Tokyo (JP)

(21) Appl. No.: 11/051,634

(22) Filed: Jan. 27, 2005

(51) Int. Cl. B41M 5/40

(52) U.S. Cl. 428/32.84

(57) ABSTRACT

A thermal transfer recording medium comprising a thermally-melting layer comprising a polyolefin wax defined in the following items (i) to (iv): (i) the wax comprises an ethylene homopolymer or a copolymer made from ethylene and an α-olefin having 3 to 10 carbon atoms, (ii) the wax has a number-average molecular weight (Mn) of 400 to 3,000, the molecular weight being measured by gel permeation chromatography (GPC), (iii) the wax has a melting point of 60 to 120° C., the melting point being measured with a differential scanning calorimeter (DSC), and (iv) the softening point (Ts (° C.)) of the wax and the penetration (Y (dmm)) thereof satisfy a specific relationship expression. The thermal transfer recording medium can provide printed images having a superior sharpness (dot reproducibility) and an improved abrasion resistance at a low energy.

### TECHNICAL FIELD

The present invention relates to a thermal transfer recording medium, more specifically, a thermal transfer recording medium which makes it possible to form images superior in abrasion resistance and sharpness at a low energy.

### RELATED ART

In recent years, there has widely been carried out printing in a thermal transfer recording device by use of a thermal transfer recording medium (ink ribbon) in which a thermal transfer layer made of a colorant and a binder is formed on a support. Such a printing method using a thermal transfer recording device is a method of bringing a thermal head into contact with the support side of a thermal transfer recording medium, heating heat-points (dots) fitted to the thermal head correspondingly to information to be output, thereby melting or softening the thermal transfer layer of the medium, correspondingly to the heat-points, so as to detach the given portions of the layer from the support and transfer the portions to a surface of a transfer-receiving medium such as paper.

For example, Japanese Patent Application Laid-Open (JP-A) No. 4-59293 discloses, as such a thermal transfer recording medium, a medium in which a relatively soft polyethylene wax having a penetration of 30 or more and a density of 0.93 or less is used in a thermally-melting ink layer to improve the high-speed printability of the medium. However, when this soft polyethylene wax is used, a problem that printed images are poor in abrasion resistance may be caused.

Japanese Patent Application Publication (JP-B) No. 5-48756 states that in a thermal transfer recording medium in which a thermal releasing layer and a thermal transfer ink layer are successively laminated, images the void amount of which is small can be printed on low-smoothness paper by utilizing a polyethylene resin having a molecular weight of 1,000 to 100,000 and a melt viscosity of 100 to 10,000 cps in the ink layer. This recording medium has an advantageous effect on a reduction in voids in printed images, based on bridge effect, since the melt viscosity of the polyethylene resin is high. However, the shear force of the ink layer is increased so as to lower the sharpness (dot reproducibility) of the printed images and the thermal sensitivity of the recording medium.

Furthermore, JP-B No. 5-80355 discloses a thermal transfer recording medium in which a releasing layer is made from an aqueous dispersion-liquid made mainly of polyethylene wax and an ink layer made of a thermally melting resin containing no wax and a colorant is formed on the releasing layer. However, a fall in the sharpness (dot reproducibility) of printed images and the thermal sensitivity of the recording medium may be caused.

### DISCLOSURE OF THE INVENTION

An object of the present invention is to provide a thermal transfer recording medium which makes it possible to obtain images superior in sharpness (dot reproducibility) and abrasion resistance at a low energy.

The present invention is a thermal transfer recording medium comprising a support and a thermally-melting layer formed on or over the support, in which the thermally-melting layer comprises a polyolefin wax defined in the following items (i) to (iv):
(i) the wax is made of an ethylene homopolymer or a copolymer made from ethylene and an α-olefin having 3 to 10 carbon atoms,
(ii) the wax has a number-average molecular weight (Mn) of 400 to 3,000, the molecular weight being measured by gel permeation chromatography (GPC),
(iii) the wax has a melting point of 60 to 120° C., the melting point being measured with a differential scanning calorimeter (DSC), and
(iv) the softening point (Ts (° C.)) of the wax and the penetration (Y (dmm)) thereof satisfy the following relationship expression:
   Y≦−0.220×Ts+32.0 (I)

### BEST MODES FOR CARRYING OUT THE INVENTION

The thermal transfer recording medium according to the present invention is described in detail hereinafter.

The thermal transfer recording medium according to the present invention is a thermal transfer recording medium comprising a support and a thermally-melting layer formed on or over the support, in which the thermally-melting layer comprises the following polyolefin wax.

[Polyolefin Wax]

The polyolefin wax used in the present invention is an ethylene homopolymer or a copolymer made from ethylene and an α-olefin.

The α-olefin is preferably an α-olefin having 3 to 10 carbon atoms, such as propylene which has 3 carbon atoms, 1-butene which has 4 carbon atoms, 1-pentene which has 5 carbon atoms, 1-hexene or 4-methyl-1-pentene which has 6 carbon atoms, or 1-octene which has 8 carbon atoms, and is more preferably propylene, 1-butene, 1-hexene, or 4-methyl-1-pentene. The ratio of structural units derived from such an α-olefin in the polyolefin wax is preferably 20% or less by mole, more preferably 10% or less by mole.

The polyolefin wax has a number-average molecular weight (Mn) of 400 to 3,000, preferably 500 to 2,700, more preferably 600 to 2,500. The molecular weight is measured by gel permeation chromatography (GPC). When the number-average molecular weight of the polyolefin wax is in the above-mentioned range, the thermally-melting layer is sharply melted by heat given from a thermal head, and has a good transferability.

The polyolefin wax has a melting point of 60 to 120° C., preferably 65 to 110° C., more preferably 70 to 100° C. The melting point is measured with a differential scanning calorimeter (DSC) When the melting point of the polyolefin wax is in the above-mentioned range, the sharpness of printed images and the transferability are superior.

Furthermore, the softening point (Ts (° C.)) of the polyolefin wax and the penetration (Y (dmm)) thereof satisfy the following relationship expression:
Y≦−0.220×Ts+32.0 (I)
preferably the following relationship expression:
Y≦−0.220×Ts+30.0 (Ia), and
more preferably the following expression:
Y≦−0.220×Ts+28.0 (Ib)

When the softening point (Ts) and the penetration (Y) satisfy the above-mentioned relationship expression, balance between the abrasion resistance and the high-speed printability is improved.

The polyolefin wax usually has a density of 880 to 950 kg/m², preferably 880 to 930 kg/m², more preferably 880 to 910 kg/m². The density is measured by the density-gradient tube method. When the density of the polyolefin is in the above-mentioned range, it is possible to obtain printed images which have a small amount of background stains and have a high thermal sensitivity and a superior sharpness.

About the polyolefin wax, the ratio of the weight-average molecular weight (Mw) to the number-average molecular weight (Mn) (that is, Mw/Mn) is usually 3.2 or less, preferably 3.0 or less, more preferably 2.8 or less. When the ratio Mw/Mn is in the above-mentioned range, it is possible to obtain printed images which have a small amount of background stains and have a superior sharpness.

The penetration of the polyolefin wax is usually from 1 to 30, preferably from 2 to 25. The penetration is measured by the method described in JIS K 2207. When the penetration of the polyolefin wax is in the above-mentioned range, printed images good in abrasion resistance can be obtained.

The acetone-extraction fraction of the polyolefin wax is usually from 0 to 30% by weight, preferably from 0 to 15% by weight. When the acetone-extraction fraction of the polyolefin wax is in the above-mentioned range, it is possible to obtain printed images which have a small amount of background stains and have a high thermal sensitivity and a superior sharpness.

The acetone-extraction fraction is measured as follows.

A Soxhlet extractor is used to subject polyolefin wax to extraction for 5 hours, and the fraction is obtained from the following expression:
Extracted amount (g)/Charged amount (g)×100

Furthermore, about the polyolefin wax, the relationship between the crystallization temperature (Tc (° C.)) thereof, measured with a differential scanning calorimeter (DSC) at a temperature-lowering rate of 2° C./min., and the density (D (kg/m³)) thereof, measured by the density-gradient tube method, desirably satisfies the following expression (II):
0.501×D−366≧Tc (II),
more desirably satisfies the following expression (IIa):
0.501×D−366.5≧Tc (IIa), and
even more desirably satisfies the following expression (IIb)
0.501×D−367≧Tc (IIb)

When the relationship between the crystallization temperature (Tc) of the polyolefin wax and the density (D) thereof satisfies the above-mentioned expression, the comonomer composition of the polyolefin wax becomes more homogeneous so that the amount of sticky components of the polyolefin wax tends to become small.

The polyolefin wax is preferably an ethylene/α-olefin copolymer made from ethylene and propylene or 1-butene.

The polyolefin wax is a sold at ambient temperature and becomes a low-viscosity liquid at 80 to 120° C. or higher.

In the invention, the polyolefin wax is preferably an ethylene homopolymer produced by use of a metallocene catalyst, or a copolymer made from ethylene and an α-olefin having 3 to 10 carbon atoms and produced by use thereof.

The polyolefin wax can be produced by use of a metallocene catalyst as described below, which comprises a metallocene compound of a transition metal selected from among the group IV of the periodic table, and an organoaluminum oxy-compound and/or ionized ionic compound.

(Metallocene Compound)

The metallocene compound, which constitutes the metallocene catalyst, is a metallocene compound of a transition metal selected from among the group IV in the periodic table, and a specific example thereof is a compound represented by the following general formula (1):
M¹Lx (1)
wherein M¹ is a transition metal selected from among the group IV of the periodic table, x is a valence of the transition metal M¹, and L's are ligands.

Examples of the transition metal represented by M¹ include zirconium, titanium, and hafnium. L's are ligands which coordinate the transition metal M¹. At least one out of L's is a ligand having a cyclopentadienyl skeleton. This ligand having a cylopentadienyl skeleton may have a substituent.

Examples of the ligand L having a cyclopentadienyl skeleton include alkyl- and cycloalkyl-substituted cyclopentadienyl groups, such as cyclopentadienyl, methylcyclopentadienyl, ethylcyclopentadienyl, n- and i-propylcyclopentadienyl, n-, i-, sec- and t-butylcyclopentadienyl, dimethylcyclopentadienyl, methylpropylcyclopentadienyl, methylbutylcyclopentadienyl, and methylbenzylcyclopentadienyl groups; and indenyl, 4,5,6,7-tetrahydroindenyl and fluorenyl groups. Any hydrogen atom of this ligand having a cyclopentadienyl skeleton may be substituted with a halogen atom or a trialkylsilyl group.

In the case where the above-mentioned metallocene compound has, as the ligands L's, two or more ligands which each have a cyclopentadienyl skeleton, two out of these ligands may be bonded to each other through an alkylene group such as ethylene or propylene, a substituted alkylene group such as isopropylidene or diphenylmethylene; or a substituted or unsubstituted silylene group such as silylene, dimethylsilylene, diphenylsilylene or methylphenylsilylene.

Examples of the ligand L other than the ligand having a cyclopentadienyl skeleton (i.e., the ligand L having no cyclopentadienyl skeleton) include hydrocarbon groups having 1 to 12 carbon atoms, alkoxy groups, aryloxy groups, sulfone-acid-containing group (—SO₃R¹ wherein R¹ represents an alkyl group, an alkyl group substituted with one or more halogen atoms, an aryl group, or an aryl group substituted with one or more aryl or alkyl groups substituted with one or more halogen atoms), halogen atoms, and a hydrogen atom.

### METALLOCENE COMPOUND EXAMPLE 1

In the case where the valance of the transition metal in the metallocene compound represented by the general formula (1) is, for example, 4, the compound is specifically represented by the following general formula (2):
R²ₖR³ₗR⁴ₘR⁵ₙM¹ (2)
wherein M¹ is a transition metal selected from among the group IV of the periodic table; R² is a group (ligand) having a cyclopentadienyl skeleton; and R³, R⁴ and R⁵ are each independently a group (ligand) having or not having a cyclopentadienyl skeleton; k is an integer of 1 or more; and k+l+m+n=4.

Examples of the metallocene compound having at least two ligands which each have a cyclopentadienyl skeleton wherein M¹ is zirconium are as follows:

bis(cyclopentadienyl)zirconium monochloride monohydride, bis(cyclopentadienyl)zirconium dichloride, bis(1-methyl-3-butylcyclopentadienyl)zirconium bis(trifluoromethanesulfonate), and bis(1,3-dimethylcyclopentadienyl)zirconium dichloride.

A compound may be used in which the cyclopentadienyl group substituted at the 1,3-positions of each of the above-mentioned compounds is replaced by a cyclopentadienyl group substituted at the 1,2-positions.

Another example of the metallocene compound is -a bridge type metallocene compound in which two or more (for example, R² and R³) out of R², R³, R⁴ and R⁵ in the general formula (2) have groups (ligands) which each have a cyclopentadienyl skeleton, and these two or more groups are bonded to each other through an alkylene group, a substituted alkylene group, a silylene group, a substituted silylene group or the like. In this case, R⁴ and R⁵ each independently represent the above-mentioned ligand L other than the ligand having a cyclopentadienyl skeleton.

Examples of the bridge type metallocene compound include ethylenebis(indenyl)dimethylzirconium, ethylenebis(indenyl)zirconium dichloride, isopropylidene(cyclopentadienyl-fluorenyl)zirconium dichloride, diphenylsilylenebis(indenyl) zirconium dichloride, and methylphenylsilylene(indenyl)zirconium dichloride.

### METALLOCENE COMPOUND EXAMPLE 2

Still another example of the metallocene compound is a compound described in JP-A No. 4-268307 and represented by the following general formula (3):

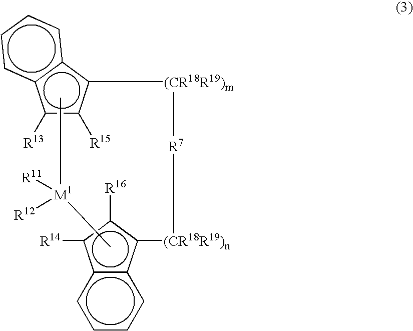

In the formula, M¹ is a transition metal in the group IV of the periodic table, and specific examples thereof include titanium, zirconium, and hafnium.

R¹¹ and R¹² may be the same or different, and are each a hydrogen atom; an alkyl group having 1 to 10 carbon atoms; an alkoxy group having 1 to 10 carbon atoms; an aryl group having 6 to 10 carbon atoms; an aryloxy group having 6 to 10 carbon atoms; an alkenyl group having 2 to 10 carbon atoms; an arylalkyl group having 7 to 40 carbon atoms; an alkylaryl group having 7 to 40 carbon atoms; an arylalkenyl group having 8 to 40 carbon atoms; or a halogen atom. R¹¹ and R¹² are each preferably a chlorine atom.

R¹³ and R¹⁴ may be the same or different, and are each a hydrogen atom; a halogen atom; an alkyl group which has 1 to 10 carbon atoms and may be halogenated; an aryl group having 6 to 10 carbon atoms; -or N(R²⁰)₂, —SR²⁰, —OSi(R²⁰)₃, —Si(R²⁰)₃ or —P(R²⁰)₂ group wherein R²⁰ is a halogen atom (preferably a chlorine atom), an alkyl group having 1 to 10 carbon atoms, preferably 1 to 3 carbon atoms, or an aryl group having 6 to 10 carbon atoms, preferably 6 to 8 carbon atoms. In particular, R¹³ and R¹⁴ are each preferably a hydrogen atom.

R¹⁵and R¹⁶ are identical with R¹³ and R¹⁴ except that R¹⁵ and R¹⁶ are not each a hydrogen atom, and may the same or different. R¹⁵ and R¹⁶ are preferably the same as each other. R¹⁵ and R¹⁶ are each preferably an alkyl group which has 1 to 4 carbon atoms and may be halogenated. Specific examples of the alkyl group include methyl, ethyl, propyl, isopropyl, butyl, isobutyl, and trifluoromethyl. Methyl is particularly preferable.

In the general formula (3), R¹⁷ is selected from the following: 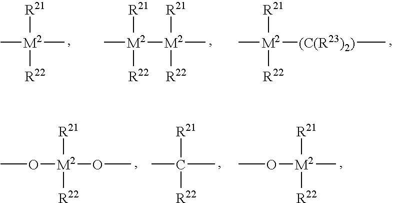
═BR²¹, ═AlR²¹, —Ge—, —Sn—, —O—, —S—, ═SO, ═SO₂, ═NR²¹, ═CO, ═PR²¹, ═P(O)R²¹ and others. M² is silicon, germanium, or tin, preferably silicon or germanium.

R²¹, R²² and R²³ may be the same or different, and are each a hydrogen atom; a halogen atom; an alkyl group having 1 to 10 carbon atoms; a fluoroalkyl group having 1 to 10 carbon atoms; an aryl group having 6 to 10 carbon atoms; a fluoroarkyl atoms having 6 to 10 carbon atoms; an alkoxy group having 1 to 10 carbon atoms; an alkenyl group having 2 to 10 carbon atoms; an arylalkyl group having 7 to 40 carbon atoms; an arylalkenyl group having 8 to 40 carbon atoms; or an alkylaryl group having 7 to 40 carbon atoms.

“R²¹ and R²²” or “R²¹ and R²³” may be combined with atoms to which they are bonded, so as to form a ring.

R¹⁷ is preferably ═CR²¹R²², ═SiR²¹R²², ═GeR²¹R²², —O—, —S—, ═SO, ═PR²¹ or ═P(O)R²¹.

R¹⁸ and R¹⁹ may be the same or different, and are each the same as R²¹.

m and n may be the same or different, and are each 0, 1 or 2, preferably 0 or 1. m+n is 0, 1 or 2, preferably 0 or 1.

Examples of the metallocene compound represented by the general formula (3) include the following compounds: rac-ethylene(2-methyl-1-indenyl)²-zirconium-dichloride, and rac-dimethylsilylene(2-methyl-1-indenyl)²-zirconium-dichlor ide. These metallocene compounds can be produced by, for example, the method described in JP-A No. 4-268307.

### METALLOCENE COMPOUND EXAMPLE 3

As the metallocene compound, a metallocene compound represented by the following general formula (4) can be used:

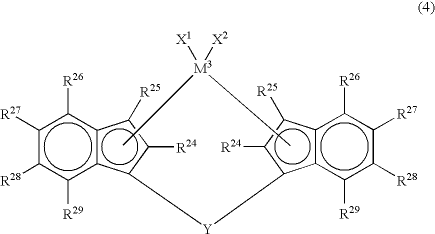

In the formula, M³ represents a transition metal atom in the group IV of the periodic table, and specific examples thereof include titanium, zirconium and hafnium.

R²⁴ and R²⁵ may be the same or different, and each represent a hydrogen atom, a halogen atom, a hydrocarbon group having 1 to 20 carbon atoms, a halogenated hydrocarbon group having 1 to 20 carbon atoms, a silicon-containing group, an oxygen-containing group, a sulfur-containing group, a nitrogen-containing group or a phosphorus-containing group.

R²⁴ is preferably a hydrocarbon group, more preferably an alkyl group having 1 to 3 carbon atoms, which is methyl, ethyl or propyl.

R²⁵is preferably a hydrogen atom, or a hydrocarbon group, more preferably a hydrogen atom, or an alkyl group having 1 to 3 carbon atoms, which is methyl, ethyl or propyl.

R²⁶, R²⁷, R²⁸and R²⁹ may be the same or different, and each represent a hydrogen atom, a halogen atom, a hydrocarbon group having 1 to 20 carbon atoms, or a halogenated hydrocarbon group having 1 to 20 carbon atoms. Of these, preferred are a hydrogen atom, the hydrocarbon group or the halogenated hydrocarbon group. At least one pair of R²⁶ and R²⁷, R²⁸ and R²⁹, and R²⁸ and R²⁹ may be combined with atoms to which they are bonded, so as to form a monocyclic aromatic ring. When two or more hydrocarbon groups or halogenated hydrocarbon groups are present besides the groups which constitute the aromatic ring, these may be bonded to each other to form a ring. When R²⁹ is a substituent other than any aromatic group, R²⁹ is preferably a hydrogen atom.

X¹ and X² may be the same or different, and each represent a hydrogen atom, a halogen atom, a hydrocarbon group having 1 to 20 carbon atoms, a halogenated hydrocarbon group having 1 to 20 carbon atoms, an oxygen-containing group or a sulfur-containing group.

Y represents a bivalent hydrocarbon group having 1 to 20 carbon atoms, a bivalent halogenated hydrocarbon group having 1 to 20 carbon atoms, a bivalent silicon-containing group, a bivalent germanium-containing group, a bivalent tin-containing group, —O—, —CO—, —S—, —SO—, —SO₂—, —NR³⁰—, —P(R³⁰)—, —P(O) (R³⁰), —BR³⁰—, or —AlR³⁰ wherein R³⁰ represents a hydrogen atom, a halogen atom, a hydrocarbon group having 1 to 20 carbon atoms, or a halogenated hydrocarbon group having 1 to 20 carbon atoms.

Examples of the ligand which contains a cyclic aromatic ring formed by combining at least one pair of R²⁶ and R²⁷, R²⁷ and R²⁸, and R²⁸ and R²⁹ and coordinates M³ in the formula (4) include ligands represented by the following formulae: 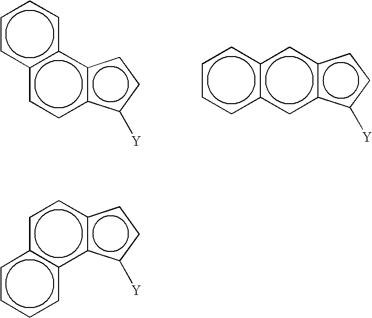
wherein Y has the same meaning as described above.

### METALLOCENE COMPOUND EXAMPLE 4

As the metallocene compound, a metallocene compound represented by the following general formula (5) can also be used:

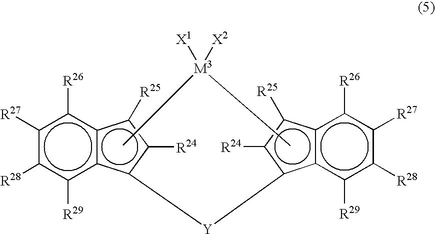

In the formula, M³, R²⁴, R²⁵, R²⁶, R²⁷, R²⁸ and R²⁹ are the same as in the general formula (4).

It is preferred that two groups, one of which is R²⁶, out of R²⁶, R²⁷, R²⁸ and R²⁹ are alkyl groups. It is preferred that R²⁶ and R²⁸, or R²⁸ and R²⁹ are alkyl groups. The alkyl groups are preferably secondary or tertiary alkyl groups. The alkyl groups may each be substituted with a halogen atom or a silicon-containing group. Examples of the halogen atom and the silicon-containing group are the same substituents as exemplified about R²⁴ and R²⁵.

Of R²⁶, R²⁷, R²⁸ and R²⁹, one or more groups other than alkyl groups are preferably hydrogen atoms.

Two groups selected from R²⁶, R²⁷, R²⁸ and R²⁹ may be bonded to each other to form a mono-ring or poly-ring which is not any aromatic ring. Examples of the halogen atom are the same as exemplified about R²⁴ and R²⁵.

X¹, X² and Y are the same as described above.

Specific examples of the metallocene compound represented by the general formula (5) include

rac-dimethylsilylene-bis(4,7-dimethyl-1-indenyl)zirconium dichloride,

rac-dimethylsilylene-bis(2,4,7-trimethyl-1-indenyl)zirconiu m dichloride,

rac-dimethylsilylene-bis(2,4,6-trimethyl-1-indenyl)zirconiu m dichloride.

Transition metal compounds in which zirconium in these compounds is substituted with titanium or hafnium can be used. Usually, the transition metal compounds are each used as a racemic body, but the R body or S body thereof may be used.

### METALLOCENE COMPOUND EXAMPLE 5

As the metallocene compound, a metallocene compound represented by the general formula (6) can be used:

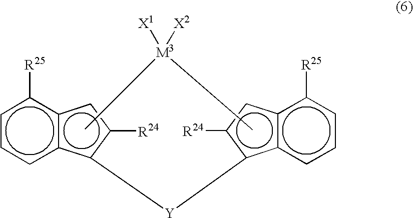

In the formula, M³, R²⁴, X¹, X² and Y are the same as in the general formula (4).

R²⁴ is preferably a hydrocarbon group, more preferably an alkyl group having 1 to 4 carbon atoms, which is methyl, ethyl, propyl, or butyl.

R²⁵ represents an aryl group having 6 to 16 carbon atoms. R²⁵ is preferably phenyl or naphthyl. The aryl group may be substituted with a halogen atom, a hydrocarbon group having 1 to 20 carbon atoms, or a halogenated hydrocarbon group having 1 to 20 carbon atoms.

X¹ and X² are each preferably a halogen atom, or a hydrocarbon group having 1 to 20 carbon atoms.

Specific examples of the metallocene compound represented by the general formula (6) include the following:

rac-dimethylsilylene-bis(4-phenyl-1-indenyl)zirconium dichloride, rac-dimethylsilylene-bis(2-methyl-4-phenyl-1-indenyl)zircon ium dichloride, rac-dimethylsilylene-bis(2-methyl-4-(α-naphthyl)-1-indenyl) zirconium dichloride, rac-dimethylsilylene-bis(2-methyl-4-(β-naphthyl)-1-indenyl) zirconium dichloride, and rac-dimethylsilylene-bis(2-methyl-4-(1-anthryl)-1-indenyl)d ichloride. Transition metal compounds in which zirconium in these compounds is substituted with titanium or hafnium can be used.

### METALLOCENE COMPOUND EXAMPLE 6

As the metallocene compound, a metallocene compound represented by the general formula (7) can be used:
LaM⁴X³₂ (7)

In the formula, M⁴ is a metal in the group IV of the periodic table, or a lanthanoid metal. La is a derivative of a non-localized π bonding group, and is a group giving a restrained geometric shape to the active site of the metal M⁴. X³'s may be the same or different, and are each a hydrogen atom, a halogen atom, a hydrocarbon group having 20 or less carbon atoms, a silyl group having 20 or less silicon atoms, or a germyl group having 20 or less germanium atoms.

Of these compounds, preferable is a compound represented by the following formula (8):

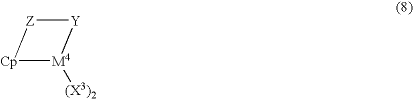

M⁴ is titanium, zirconium or hafnium.

X³ is the same as described about the general formula (7).

Cp is a substituted cyclopentadienyl group which is π-bonded to M⁴ and has a substituent Z.

Z is oxygen, sulfur, boron, or an element in the group IV of the periodic table (for example, silicon, germanium or tin).

Y is a ligand containing phosphorus, oxygen or sulfur, and Z and Y may combined with each other to form a condensed ring.

Specific examples of the metallocene compound represented by the formula (8) include dimethyl (t-butylamide) (tetramethyl-η⁵-cyclopentadienyl)sila ne)titanium dichloride, ((t-butylamide) (tetramethyl-η⁵-cyclopentadienyl)-1,2-ethane diyl)titanium dichloride; and compounds in which titanium in these metallocene compounds is substituted with zirconium or hafnium.

### METALLOCENE COMPOUND EXAMPLE 7

As the metallocene compound, a metallocene compound represented by the general formula (9) can be used:

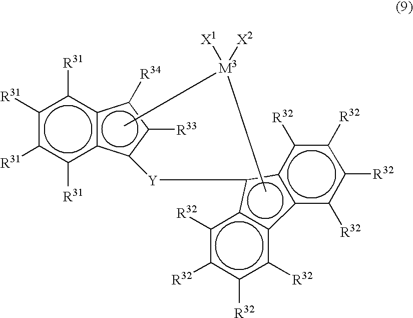

M³is a transition metal atom in the group IV of the periodic table. M³ is specifically titanium, zirconium or hafnium, and is preferably zirconium.

R³¹'s maybe the same or different, and at least one thereof is an aryl group having 11 to 20 carbon atoms, an arylalkyl group having 12 to 40 carbon atoms, an arylalkenyl group having 13 to 40 carbon atoms, an alkylaryl group having 12 to 40 carbon atoms, or a silicon-containing group. Alternatively, at least two adjacent groups out of the groups represented by R³¹'s are combined with carbon atoms to which these groups are bonded, so as to form one or more aromatic rings or aliphatic rings. In this case, the total number of the carbon atoms in the ring(s) made from the R³¹'s, these carbon atoms including the carbon atoms to which the R³¹'s are bonded, is from 4 to 20.

R³¹ or R³¹'s which are not any aryl, arylalkyl, arylalkenyl or alkylaryl group and which do not constitute any aromatic ring or aliphatic ring are each a hydrogen atom, a halogen atom, an alkyl group having 1 to 10 carbon atoms, or a silicon-containing group.

R³²'s may be the same or different, and are each a hydrogen atom, a halogen atom, an alkyl group having 1 to 10 carbon atoms, an aryl group having 6 to 20 carbon atoms, an alkenyl group having 2 to 10 carbon atoms, an arylalkyl group having 7 to 40 carbon atoms, an arylalkenyl group having 8 to 40 carbon atoms, an alkylaryl group having 7 to 40 carbon atoms, a silicon-containing group, an oxygen-containing group, a sulfur-containing group, a nitrogen-containing group or a phosphorus-containing group.

At least two adjacent groups out of the groups represented by R³²'s may be combined with carbon atoms to which these groups are bonded, so as to form one or more aromatic rings or aliphatic rings. In this case, the total number of the carbon atoms in the ring(s) made from the R³²'s, these carbon atoms including the carbon atoms to which the R³²'s are bonded, is from 4 to 20. R³² or R³²'s which do not constitute any aromatic ring or aliphatic ring are each a hydrogen atom, a halogen atom, an alkyl group having 1 to 10 carbon atoms, or a silicon-containing group.

The group in which two out of the groups represented by R³²'s constitute one or more aromatic rings or aliphatic rings may be an embodiment in which a fluorenyl group has a structure represented by the following formula:

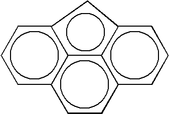

R³²'s are each preferably a hydrogen group or an alkyl group, more preferably a hydrogen atom or a hydrocarbon group having 1 to 3 carbon atoms, which is methyl, ethyl or propyl. A preferable example of the fluorenyl group having R³² 's as such substituents is a 2,7-dialkyl-fluorenyl group. The alkyl groups of the 2,7-dialkyl group in this case may each be an alkyl group having 1 to 5 carbon atoms. R³¹('s) may be the same as or different from R³²('s).

R³³ and R³⁴ may be the same or different, and are each the same atom or group as described above, that is, a hydrogen atom, a halogen atom, an alkyl group having 1 to 10 carbon atoms, an aryl group having 6 to 20 carbon atoms, an alkenyl group having 2 to 10 carbon atoms, an arylalkyl group having 7 to 40 carbon atoms, an arylalkenyl group having 8 to 40 carbon atoms, an alkylaryl group having 7 to 40 carbon atoms, a silicon-containing group, an oxygen-containing group, a sulfur-containing group, a nitrogen-containing group or a phosphorus-containing group. At least one of R³³ and R³⁴ is preferably an alkyl group having 1 to 3 carbon atoms.

X¹ and X² may be the same or different, and are each a hydrogen atom, a halogen atom, a hydrocarbon group having 1 to 20 carbon atoms, a halogenated hydrocarbon group having 1 to 20, an oxygen-containing group, a sulfur-containing group, or a nitrogen-containing group, or X¹ and X² may constitute a conjugated diene residue.

The conjugated diene residue made from X¹ and X² is preferably a residue of 1,3-butadiene, 2,4-hexadiene, 1-phenyl-1,3-pentadiene or 1,4-diphenylbutadiene. The residue may further be substituted with a hydrocarbon group having 1 to 10 carbon atoms.

X¹ and X²are each preferably a halogen atom, a hydrocarbon group having 1 to 20 carbon atoms, or a sulfur-containing group.

Y represents a bivalent hydrocarbon group having 1 to 20 carbon atoms, a bivalent halogenated hydrocarbon group having 1 to 20 carbon atoms, a bivalent silicon-containing group, a bivalent germanium-containing group, a bivalent tin-containing group, —O—, —CO—, —S—, —SO—, —SO₂—, —NR³⁵—, —P(R³⁵)—, —P(O)(R³⁵)—, —BR³⁵—, or —AlR³⁵— wherein R³⁵ represents a hydrogen atom, a halogen atom, a hydrocarbon group having 1 to 20 carbon atoms, or a halogenated hydrocarbon group having 1 to 20 carbon atoms.

Of these bivalent groups, preferable are groups in which the shortest linking moiety of —Y— is made of one or two atoms. R³⁵ is a halogen atom, a hydrocarbon group having 1 to 20 carbon atoms, or a halogenated hydrocarbon group having 1 to 20 carbon atoms.

Y is preferably a bivalent hydrocarbon group having 1 to 5 atoms, a bivalent silicon-containing group or a bivalent germanium-containing group, more preferably a bivalent silicon-containing group, even more preferably alkylsilylene, alkylarylsilylene or arylsilylene.

### METALLOCENE COMPOUND EXAMPLE 8

As the metallocene compound, a metallocene compound represented by the general formula (10) can be used:

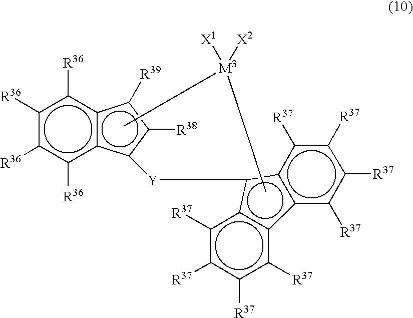

In the formula, M³ is a transition metal atom in the group IV of the periodic table. M³ is specifically titanium, zirconium or hafnium, and is preferably zirconium.

R³⁶'s may be the same or different, and are each a hydrogen atom, a halogen atom, an alkyl group having 1 to 10 carbon atoms, an aryl group having 6 to 10 carbon atoms, an alkenyl group having 2 to 10 carbon atoms, a silicon-containing group, an oxygen-containing group, a sulfur-containing group, a nitrogen-containing group or a phosphorus-containing group. The alkyl or alkenyl group may be substituted with a halogen atom.

R³⁶'s are each preferably an alkyl or aryl group, or a hydrogen atom among the above-mentioned atoms and groups, more preferably a hydrocarbon group having 1 to 3 carbon atoms, which is methyl, ethyl, n-propyl or i-propyl, an aryl group such as phenyl, α-naphthyl or β-naphthyl, or a hydrogen atom.

R³⁷'s may be the same or different, and are each a hydrogen atom, a halogen atom, an alkyl group having 1 to 10 carbon atoms, an aryl group having 6 to 20 carbon atoms, an alkenyl group having 2 to 10 carbon atoms, an arylalkyl group having 7 to 40 carbon atoms, an arylalkenyl group having 8 to 40 carbon atoms, an alkylaryl group having7 to 40 carbon atoms, a silicon-containing group, an oxygen-containing group, a sulfur-containing group, a nitrogen-containing group or a phosphorus-containing group. The alkyl, aryl, alkenyl, arylalkyl, arylalkenyl, or alkylaryl group may be substituted with a halogen atom.

R³⁷'s are each preferably a hydrogen atom or alkyl group among the above-mentioned atoms and groups, more preferably a hydrocarbon group having 1 to 4 carbon atoms, which is methyl, ethyl, n-propyl, i-propyl, n-butyl or tert-butyl. R³⁶('s) may be the same as or different from R³⁷('s).

One of R³⁸ and R³⁹ is an alkyl group having 1 to 5 carbon atoms, and the other is a hydrogen atom, a halogen atom, an alkyl group having 1 to 10 carbon atoms, an alkenyl group having 2 to 10 carbon atoms, a silicon-containing group, an oxygen-containing group, a sulfur-containing group, a nitrogen-containing group or a phosphorus-containing group.

It is preferable that one of R³⁸ and R³⁹ is an alkyl group having 1 to 3 carbon atoms, which is methyl, ethyl or propyl, and the other is a hydrogen atom.

X¹ and X² may be the same or different, and are each a hydrogen atom, a halogen atom, a hydrocarbon group having 1 to 20 carbon atoms, a halogenated hydrocarbon group having 1 to 20 carbon atoms, an oxygen-containing group, sulfur-containing group or a nitrogen-containing group. X¹ and X²may constitute a conjugated diene residue. X¹ and X² are each preferably a halogen atom or a hydrocarbon group having 1 to 20 carbon atoms among the above-mentioned atoms and groups.

Y represents a bivalent hydrocarbon group having 1 to 20 carbon atoms, a bivalent halogenated hydrocarbon group having 1 to 20 carbon atoms, a bivalent silicon-containing group, a bivalent germanium-containing group, a bivalent tin-containing group, —O—, —CO—, —S—, —SO—, —SO₂—, —NR⁴⁰—, —P(R⁴⁰)—, —P(O)(R⁴⁰ )—, —BR⁴⁰—, or —AlR⁴⁰— wherein R⁴⁰ represents a hydrogen atom, a halogen atom, a hydrocarbon group having 1 to 20 carbon atoms, or a halogenated hydrocarbon group having 1 to 20 carbon atoms.

Of these, preferable are a bivalent hydrocarbon group having 1 to 5 carbon atoms, a bivalent silicon-containing group or a bivalent germanium-containing group. More preferable is a bivalent silicon-containing group, and even more preferable is alkylsilylene, alkylarylsilylene or arylsilylene.

The metallocene compounds described above are used alone or in combination of two or more thereof. The metallocene compounds may be diluted with a hydrocarbon, a halogenated hydrocarbon or the like.

(Organoaluminum Oxy-Compound)

The organoaluminum oxy-compound may be a known aluminoxane, or an organoaluminum oxy-compound insoluble in benzene.

The known aluminoxane is specifically represented by the following formulae: 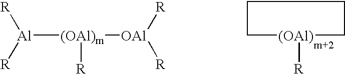
wherein R is a hydrocarbon group such as a methyl, ethyl, propyl or butyl group, preferably a methyl or ethyl group, more preferably a methyl group; and m is an integer of 2 or more, preferably an integer of 5 to 40.

The aluminoxane may be made from mixed alkyloxy aluminum units each composed of an alkyloxy aluminum unit represented by the formula (OAl(R′)) and an alkyloxy aluminum unit represented by the formula (OAl(R″)) wherein R′ and R″ are hydrocarbon groups, examples of which are the same as described about R, and are different from each other. The organoaluminum oxy-compound may contain a small amount of an organic compound component of a metal other than aluminum.

(Ionized Ionic Compound)

Examples of the ionized ionic compound, which may be referred to as the ionic ionized compound or ionic compound as the case may be, include Lewis acids, ionic compounds, boron compounds, and carborane compounds.

The Lewis acids may be compounds represented by BR₃ wherein R is a phenyl which may have a substituent such as fluorine, a methyl group, or a trifluoromethyl group; or fluorine. Specific examples of the Lewis acids include trifluoroboron, triphenylboron, tris(4-fluorophenyl)boron, tris(3,5-difluorophenyl)boron, tris(4-fluoromethylphenyl)boron, tris(pentfluorophenyl)boron, tris(p-tolyl)boron, tris(o-tolyl)boron, and tris(3,5-dimethylphenyl)boron.

Examples of the ionic compounds include trialkyl-substituted ammonium salts, N,N-dialkylanilinium salts, dialkylammonium salts, and triarylphosphonium salts. Examples of the trialkyl-substituted ammonium salts as the ionic compounds include triethylammonium tetra(phenyl)boron, tripropylammonium tetra(phenyl)boron, and tri(n-butyl)ammonium tetra(phenyl)boron. Examples of the dialkylammonium salts as the ionic compounds include di(1-propyl)ammonium tetra(pentafluorophenyl)boron, and dicyclohexylammonium tetra(phenyl)boron.

Other examples of the ionic compounds include triphenylcarbonium tetrakis(pentafluorophenyl)borate, N,N-dimethylanilinium tetrakis(pentafluorophenyl)borate, and ferrocenium tetra(pentafluorophenyl)borate.

Examples of the above-mentioned borane compounds include decaborane (9), bis[tri(n-butyl)ammonium]noborate, bis[tri (n-butyl)ammonium]decaborate, and salts of metal borane anions such as bis[tri(n-butyl)ammonium]bis(dodecahydridedodecaborate) nickelate (III).

Examples of the above-mentioned carborane compounds include 4-carbanonaborane (9), 1,3-dicarbanonaborane (8), and salts of metal carborane anions such as bis[tri(n-butyl)ammonium]bis(undecahydride-7-carbaundecabor ate)nickelate (IV).

Such ionized ionic compounds may be used alone or in combination of two or more thereof. The organoaluminum oxy-compound(s) and the ionized ionic compound(s) may be used in the state that they are carried on the above-mentioned carrier compound.

When the metallocene catalyst is formed, the following organoaluminum compound may be used together with the organoaluminum oxy-compound and/or the ionized ionic compound.

(Organoaluminum Compound)

As the organoaluminum compound which is used if necessary, a compound having, in the molecule thereof, at least one Al-carbon bond can be used. Examples of this compound include an organoaluminum compound represented by the following general formula (11):
(R⁶)ₘAl(OR⁷)ₙHₚX⁴_{q} (11)
wherein R⁶ and R⁷ may be the same or different, and are each a hydrocarbon group which usually has 1 to 15 carbon atoms, preferably 1 to 4 carbon atoms; X⁴ is a halogen atom; m, n, p and q are numbers satisfying the following expressions, respectively: 0<m≦3, 0≦n<3, 0≦p<3, and 0≦q<3; and m+n+p+q=3, and

a complex alkylated compound which comprises a group I metal and aluminum is represented by the following general formula (12):
(M⁵)Al(R⁶) (12)
wherein M⁵ is Li, Na or K; and R⁶ is identical with R⁶ in the general formula (11).
(Polymerization)

The polyolefin wax used in the present invention can be obtained, for example, by homo-polymerizing ethylene, ordinarily in a liquid phase, in the presence of the above-mentioned metallocene catalyst, or copolymerizing ethylene and an α-olefin in the presence of the catalyst.

In the case where ethylene is homo-polymerized or ethylene and an α-olefin are copolymerized in the presence of the metallocene catalyst, a hydrocarbon solvent is generally used. The α-olefin may be used as a solvent. The respective monomers used at this time are as described above.

The method for the polymerization may be suspension polymerization in which polymerization is conducted in the state that generated polyolefin wax is present as particles in a solvent such as hexane, gas-phase polymerization in which polymerization is conducted using no solvent, or solution polymerization in which polymerization is conducted in the state that generated polyolefin wax is melted alone or together with a solvent at a polymerizing temperature of 140° C. or higher. Of these methods, solution polymerization is preferable from the viewpoint of both of economical efficiency and quality.

The polymerization reaction may be conducted by a batch process or continuous process. When the polymerization is carried by a batch process, the above-mentioned catalyst components are used at concentrations described below.

The concentration of the metallocene compound in the polymerization system is usually from 0.00005 to 0.1 mmol/L (of the polymerization volume), preferably from 0.0001 to 0.05 mmol/L.

The organoaluminum oxy-compound is supplied in such a manner that the mol ratio of the aluminum atoms in this compound to the transition metal atoms in the metallocene compound in the polymerization system (i.e., the mol ratio of Al/the transition metal) is set into the range of 1 to 10000, preferably 10 to 5000.

The ionized ionic compound is supplied in such a manner that the mol ratio of the ionized ionic compound to the metallocene compound in the polymerization system (i.e., the mol ratio of the ionized ion compound/the metallocene compound) is set into the range of 0.5 to 20, preferably 1 to 10.

When the organoaluminum compound is used, the amount thereof is usually from 0 to 5 mmol/L (of the polymerization volume), preferably from about 0 to 2 mmol/L.

The polymerization reaction is conducted usually at −20 to 150° C., preferably at 0 to 120° C., more preferably at −0 to 100° C., and at a pressure of more than 0 and 7.8 MPa (80 kgf/cm², gauge pressure) or less, preferably more than 0 and 4.9 MPa (50 kgf/cm², gauge pressure) or less.

Upon the polymerization, ethylene and the α-olefin, which is used if necessary, are supplied into a polymerization system so as to give a ratio making it possible to yield the polyolefin wax having the above-mentioned specified composition. Upon the polymerization, a molecular weight adjuster such as hydrogen can be added to the system.

The polymer produced by such polymerization is usually obtained as a polymer solution containing this polymer. Thus, when the solution is treated in a usual way, the polyolefin wax according to the present invention is obtained.

It is particularly preferable to use a catalyst containing any one of the metallocene compounds described in the item (Metallocene Compound Example 6) in the polymerization reaction. It is also preferable to produce an ethylene/α-olefin copolymer in the present invention.

(Modified Polyolefin Wax)

The polyolefin wax used in the present invention may be a modified polyolefin wax obtained by oxidization-modifying or acid-graft-modifying an unmodified polyolefin wax, which may be referred to as a starting polyolefin wax hereinafter.

The starting polyolefin wax is not limited to any especial kind if the wax is an ethylene homopolymer or ethylene/α-olefin copolymer which can give a polyolefin wax having the above-mentioned properties after the homopolymer or copolymer is modified. The starting polyolefin wax is preferably an ethylene homopolymer or ethylene/α-olefin copolymer which is produced using the above-mentioned metallocene catalyst and has a number-average molecular weight of 400 to 3000, a density of 885 to 960 kg/m³ and a melting point of 60 to 120° C.

(Oxidization-Modification)

The oxidization-modified polyolefin wax is obtained by bringing a starting polyolefin wax in a melt state into contact with oxygen or an oxygen-containing gas while the wax is stirred.

The starting polyolefin wax is melted usually at a temperature of 130 to 200° C., preferably 140 to 170° C.

When the starting polyolefin wax is oxidization-modified, the wax in a melt state is brought into contact with oxygen or an oxygen-containing gas while the wax is stirred, as described above. The meaning of the wording “oxygen or an oxygen-containing gas” includes pure oxygen, which is oxygen obtained by ordinary liquid-air fractional distillation or electrolysis of water and may contain a trace amount of other components as impurities; and mixed gases composed of pure oxygen and some other gas, such as air and ozone.

A preferable and specific example of the method for bringing the starting polyolefin wax into contact with oxygen or the like is a method of supplying an oxygen-containing gas continuously into a reactor from the bottom thereof to bring the gas into contact with the starting polyolefin wax. In this case, it is preferable to supply the oxygen-containing gas at an oxygen atom of 1.0 to 8.0 NL per kg of the starting mixture in each minute.

The acid value (JIS K 5902) of the thus-obtained modified polyolefin wax is preferably from6 to 30 mgKOH/g, more preferably from 10 to 25 mgKOH/g.

Herein, the acid value is the milligram value of the weight of potassium hydroxide necessary for neutralizing 1 g of a sample.

When the acid value of the oxidization-modified polyolefin wax is in the range of 6 to 30 mgKOH/g, this modified polyolefin wax usually has a penetration (JIS K 2207) of 1.0 mm or less.

(Acid-Graft Modification)

The acid-graft-modified polyolefin wax can be prepared by a method known in the prior art, and can be obtained by, for example, the following method: a method of melting and kneading (1) a starting polyolefin wax, and (2) an unsaturated carboxylic acid or derivative thereof or a sulfonic acid salt in the presence of a polymerization initiator such as (3) an organic peroxide, or a method of kneading (1) a starting polyolefin wax, and (2) an unsaturated carboxylic acid or derivative thereof or a sulfonic acid salt in a solution in which they are dissolved in an organic solvent in the presence of a polymerization initiator such as (3) an organic peroxide.

Examples of the unsaturated carboxylic acid or derivative thereof used in the acid-graft modification include acrylic acid esters such as methyl acrylate, ethyl acrylate, butyl acrylate, sec-butyl acrylate, isobutyl acrylate, propyl acrylate, isobutyl acrylate, 2-octyl acrylate, dodecyl acrylate, stearyl acrylate, hexyl acrylate, isohexyl acrylate, phenyl acrylate, 2-chlorophenyl acrylate, diethylaminoethyl acrylate, 3-methoxybutyl acrylate, diethylene glycol acrylate ethoxylate, and 2,2,2-trifluoroethyl acrylate; methacrylic acid esters such as methyl methacrylate, ethyl methacrylate, butyl methacrylate, sec-butyl methacrylate, isobutyl methacrylate, propyl methacrylate, isobutyl methacrylate, 2-octyl methacrylate, dodecyl methacrylate, stearyl methacrylate, hexyl methacrylate, decyl methacrylate, phenyl methacrylate, 2-chlorohexyl methacrylate, diethylaminoethyl methacrylate, 2-hexylethyl methacrylate, and 2,2,2-trifluoroethyl methacrylate; maleic acid esters such as ethyl maleate, propyl maleate, butyl maleate, diethyl maleate, dipropyl maleate, and dibutyl maleate; fumaric acid esters such as ethyl fumarate, butyl fumarate, and dibutyl fumarate; dicarboxylic acids such as maleic acid, fumaric acid, itaconic acid, crotonic acid, nadic acid, and methylhexahydrophthalic acid; and anhydrides such as maleic anhydride, itaconic anhydride, citracoic anhydride, allylsuccinic anhydrate, glutaconic anhydride, and nadic anhydride.

About the acid-graft-modified polyolefin wax, the amount modified with the unsaturated carboxylic acid or derivative thereof, the amount being the amount converted by KOH titration, is preferably from 30 to 100 mgKOH, more preferably from 30 to 60 mgKOH per g of the polymer.

When the amount modified with the unsaturated carboxylic acid or derivative thereof is in the above-mentioned range, the hygroscopicity of fine particles obtained from the yielded aqueous dispersion is suitable and the water resistance and weather resistance thereof tend to be superior. Moreover, phase conversion after the addition of water is sufficient and the yield of the resultant aqueous dispersion tends to be high.

When the polyolefin wax is modified with a sulfonic acid salt, the modified amount is preferably from 0.1 to 100 mmol, more preferably from 5 to 50 mmol per gram of the polymer.

When the amount modified with the sulfonic acid salt is in the above-mentioned range, unemulsified products are not easily generated and further aggregations of the sulfonic acid salt tend not to be easily generated besides the emulsion.

(Thermal Transfer Recording Medium)

The thermal transfer recording medium according to the present invention comprises a support and a thermally-melting layer formed on or over the support.

In the thermal transfer recording medium of the invention, the thermally-melting layer may contain a colorant, or a thermally-melting ink layer containing a colorant and a thermally-melting material may be formed on or over the thermally-melting layer.

(Support)

The substrate may be made of any material having an appropriate heat resistance. The substrate maybe, for example, a condenser paper sheet, a glassine paper sheet, a cellophane film, or a film made of a thermoplastic resin such as polyethylene terephthalate, polyethylene, polycarbonate, polyimide, polyamide, polyphenylenesulfide, polysulfone, aromatic polyester, polyetheretherketone, polyethersulfone, or polyetherimide. Preferable is a film made of polyethylene terephthalate, polyethylene, polyamide, or polycarbonate. The thickness of the film is preferably from 0.5 to 50 μm, more preferably from 1 to 30 μm. A back-coating layer may be formed on the surface of the resin film on which no thermally-melting layer is formed. The heat resistance of the support can be improved by forming, thereon, a known heat-resistant protective layer made of silicone resin, fluorine-containing resin, polyimide resin, epoxy resin, phenol resin, melamine resin, nitrocellulose or the like.

(Thermally-Melting Layer)

The thermally-melting layer is a releasing layer (II) which contains a polyolefin wax and is interposed between the support and an ink layer (I) or ink layer (I′) containing a polyolefin wax. The ink layer (I) and (I′) each contain a colorant.

(Polyolefin Wax)

The polyolefin wax contained in the ink layer (I) and the releasing layer (II) is a polyolefin wax as described above. The ink layer (I) contains this polyolefin wax preferably at a ratio of 30 to 90% by weight, more preferably 30 to 70% by weight. The releasing layer (II) contains the polyolefin wax preferably at a ratio of 5 to 99% by weight, more preferably 20 to 90% by weight.

(Colorant)

As the colorant (II) contained in the ink layer (I), the following known dyes may be used alone or in combination: graphite, carbon black, nigrosin dye, lamp black, Sudan Black SM, Alkaline Blue, Fast Yellow G, Benzidine Yellow, Pigment Yellow, Indo Fast Orange, Irgadine Red, Paranitroaniline Red, Toluidine Red, Carmine F8, Permanent Bordeau FRR, Pigment Orange R, Lithol Red 20, Lake red C, Rhodamine FB, Rhodamine B Lake, Methyl Violet B Lake, Photalocyanine Blue, Pigment Blue, Brilliant Green B, Phthalocyanine Green, Oil Yellow GG, Zapon Fast Yellow CGC, Kayaset Y963, Kayaset YG, Sumiblast Yellow GG, Zapon Fast Orange RR, Oil Scarlet, Sumiblast Orange G, Orazole Brown B, Zapon Fast Scarlet CG, Izenspiron Red BEH, Oil Pink OP, Victoria Blue F4R, Fastgen Blue 5007, Sudan Blue, Oil Peacock Blue, and others. The colorant(s) is/are contained in the ink layer preferably at a ratio of 1 to 95% by weight, more preferably 2 to 80% by weight.

(Different Wax Component)

The ink layer (I) and the releasing layer (II) may contain not only the above-mentioned polyolefin wax but also a wax component different from the polyolefin wax. Examples of the wax component include vegetable waxes such as rice wax, candelilla wax, and carnauba wax; animal waxes such as lanoline, beeswax, and shellac wax; mineral waxes such as montan wax; synthetic waxes such as paraffin wax, microcrystalline wax, oxidized paraffin wax, chlorinated paraffin wax, ricinoleic amide, lauric amide, oleic amide, polyethylene wax, and polyethylene oxide wax. The ratio by weight of the used polyolefin wax to the used different wax component is suitably from 100/0 to 50/50.

(Thermoplastic Resin)

The ink layer (I) and the releasing layer (II) may contain a thermoplastic resin to cause the layers to have adhesiveness to the support. The thermoplastic resin is preferably a resin having a softening temperature of 60 to 150° C. Examples of the thermoplastic resin include polyolefin and polyolefin copolymers other than polyethylene wax, vinyl chloride copolymer, vinylidene chloride copolymer, polystyrene, styrene copolymer, coumalin/indene resin, terpene resin, acrylic resin, polyacrylonitrile, acrylonitrile copolymer, diacetoneacrylamide polymer, vinyl acetate copolymer, polyvinyl ether, polyamide, polyester, polyvinylacetal resin, polyurethane resin, cellulose derivatives, polycarbonate, ionomer, a condensed product of a cyclic ketone and formaldehyde, a condensed product of o-xylene or mesitylene and formalin, a rosin modified product of this condensed product, and petroleum resin. These thermoplastic resins may be used alone or in combination of two or more thereof.

The percentage of the contained thermoplastic resin may or may not be more than that of the contained polyolefin wax.

(Ink Layer (I′))

The ink layer (I′) comprises the above-mentioned colorant, the above-mentioned different wax, and a binder made of a thermoplastic resin, and may comprise the above-mentioned polyolefin wax.

(Process for Producing the Thermal Transfer Recording Medium)

The thermal transfer recording medium according to the present invention can be produced by, for example, a method of forming the ink layer (I) on the support, or forming the ink layer (I′) and the releasing layer (II) on the support.

The ink layers (I), (I′) and the releasing layer (II) can each be formed by, for example, the method of applying components which will constitute the layer in the state that at least one part thereof is melted (the hot melting method), the method of dissolving or dispersing components which will constitute the layer into a solvent and then applying the resultant (the solvent method), or some other known method.

In the case where the hot melt method is used to form the ink layer (I) or (I′) or the releasing layer (II), the above-mentioned components which will constitute the layer are mixed and then the mixture is heated up to a temperature at which the wax or the thermoplastic resin is melted. Thereafter, the heated mixture is applied onto the support or the formed layer. After the formation of all the layers, the resultant is cut into a desired shape, whereby the thermal transfer recording medium of the invention can be produced.

In the case where the solvent method is used to form the ink layer (I) or (I′) or the releasing layer (II), the above-mentioned components which will constitute the layer are incorporated into an organic solvent, for example, a ketone solvent (such as methyl ethyl ketone, methyl isobutyl ketone, diethyl ketone, or diisopropyl ketone, analicyclic solvent (such as cyclohexanone), an aromatic solvent (such as toluene or xylene), an alcohol solvent, and ether solvent; or a mixed solvent thereof so as to prepare a coating solution. Thereafter, the coating solution is applied onto the support or the formed layer. The method for applying the coating solution may be a known method such as gravure coating, reverse roll coating, air knife coating, dip coating or spinner coating. After the coating solution is applied onto the support or the formed layer as described above, at least one portion of the solvent is removed. After the formation of all the layers, the resultant is cut into a desired shape, whereby the thermal transfer recording medium of the invention can be produced.

In the present invention, it is preferable to make the polyolefin wax into the form of particles and then incorporate them into the thermally-melting layer, that is, the ink layer (I) or the releasing layer (II). It is particularly preferable to disperse the polyolefin wax into an organic solvent to prepare an ink layer-forming solution and/or a releasing layer-forming solution, which contain(s) the polyolefin wax, and use the solution(s) to produce the thermal recording medium. According to this method, extra materials, such as a dispersing agent, are not used in a large amount; therefore, properties that the polyolefin wax has can be sufficiently exhibited to improve the abrasion resistance and the image sharpness of the recording medium.

The particle size of the polyolefin wax dispersed in the organic solvent is preferably from 0.1 to 10 μm, more preferably from 0.2 to 5 μm. When the particle size is in this range, the image sharpness may deteriorate or many voids may be generated in images.

The method for dispersing the polyolefin wax into the organic solvent may be a method of dissolving the wax components into the solvent heated and then cooling the solution to disperse the polyolefin wax, a method of mixing fine particles of the wax with the organic solvent to disperse the wax, or some other method.

It is preferable that the amount of the ink layer of the thus-produced thermal transfer recording medium is from 4 to 10 g/m² and the amount of the releasing layer, if it is formed, is from 1 to 4 g/m².

### EXAMPLES

The present invention is more specifically described by way of the following examples. However, the invention is not limited to these examples.

Physical properties of each polyethylene wax described below were measured as follows.
Mw/Mn: The ratio of the weight-average molecular weight (Mw) thereof to the number-average molecular weight (Mn), they being measured by GPC, (Mw/Mn) was evaluated. For the GPC, a measuring device Alliance 200 (manufactured by Waters Co.) was used. As columns therein, columns TSKgel GMH₆—HT×2+TSKgel GMH₆—HTL×2, manufactured by TOSOH CORPORATION, (size of each of the columns: 7.5 mm I.D.×30 cm) were used. As a shifting phase therein, o-dichlorobenzene (extra pure reagent, manufactured by Wako Pure Chemical Industries, Ltd.) was used. The measurement was made at a column temperature of 140° C. and a shifting phase flow rate of 1.0 mL/min. For the detection, a differential refractometer was used. For the calibration of the molecular weight, mono-dispersed polystyrene was used.
Density: The density was measured in accordance with JIS K 6760.
Softening point: The softening point was measured in accordance with JIS K 2207.
Penetration: The penetration was measured in accordance with JIS K 2207.
Acetone-extraction amount: The acetone-extraction amount was measured as follows. First, about 10 g of powder (about 2 mm square) of each polyethylene wax was added to a cylindrical filter paper (ADVANTEC No-84), and the weight of the whole was measured. Next, the zeolite was put into a 200-mL round bottom flask, and the weight of the whole was measured. Into the flask was put 150 mL of acetone, and the wax was subjected to Soxhlet extraction for 5 hours. The extracted liquid was evaporated and then the round bottom flask after the evaporation and the cylindrical filter paper in which an extraction residue was put were subjected to drying operation in a vacuum drier, the temperature of which was set to 80° C., for about 3 hours. The weight of each of the round bottom flask in which the extract was put and the cylindrical filter paper in which the extraction residue was put was measured. From the results of the measurements, the extracted amount was calculated.

### Synthesis Example 1

(Synthesis of Polyolefin Wax (I))

Into a stainless steel autoclave having an internal volume of 2 L and purged sufficiently with nitrogen were charged 935 mL of hexane and 65 mL of 1-butene. Hydrogen was introduced into the autoclave until the pressure thereof reached 3.5 kg/cm² (gauge pressure). Next, the temperature in the system was raised to 150° C. Thereafter, polymerization was started by pressuring 0.3 mmol of triisobuytlaluminum, 0.004 mmol of triphenylcarbonium tetrakis(pentafluorophenyl)borate, and 0.02 mmol of (t-butylamide)dimethyl(tetramethyl-η⁵-cyclopentadienyl)sila netitanium dichloride (manufactured by Sigma-Aldrich Corporation) into the system with ethylene. Thereafter, the total pressure therein was kept at 30 kg/cm² by continuous supply of only ethylene, so as to continue the polymerization at 150° C. for 20 minutes. The polymerization was stopped by adding a small amount of ethanol to the system, and then unreacted ethylene and 1-butene were purged. The resultant polymer solution was dried overnight at 100° C. under a reduced pressure. Physical properties of the resultant wax were measured. As a result, the following values were obtained:
molecular weight (GPC): Mn=600, and Mn=1000,
molecular weight distribution (GPC): Mw/Mn =1.7,
density: 920 kg/m³, melting point (according to the DSC method): 100° C., softening point: 104° C., and penetration: 7 dmm.

### Synthesis Example 2

(Synthesis of Polyolefin Wax (II))

Polymerization was performed in the same way as in synthesis Example 1 except that 920 mL of hexane and 80 mL of propane were charged and hydrogen was introduced until the pressure thereof reached 1.0 kg/cm² (gauge pressure). As a result, a wax having the following physical properties was yielded:
molecular weight (GPC): Mn=1800, and Mn=4700,
molecular weight distribution (GPC): Mw/Mn=2.6,
density: 897 kg/m³, melting point (according to the DSC method): 82° C.,
softening point: 88° C., and penetration: 12 dmm.

### Synthesis Example 3

(Preparation of Catalyst)

In a glass autoclave having an internal volume of 1.5 L, 25 g of commercially available anhydrous magnesium chloride was suspended into 500 mL of hexane. While the temperature of this suspension was kept at 30° C. and the suspension was stirred, 92 mL of ethanol was dropwise added thereto over 1 hour and further the reaction was continued for 1 hour. After the end of the reaction, 93 ml of diethylaluminum monochloride was dropwise added thereto for 1 hour, and further the reaction was continued for 1 hour. After the end of the reaction, 90 mL of titanium tetrachloride was added thereto, and the temperature of the reactor was raised to 80° C. to continue the reaction for 1 hour.

After the reaction, the solid portion was washed by decantation with hexane until free titanium was not detected. The titanium concentration in this suspension in hexane was quantitatively determined by titration. The suspension was supplied to the following experiment.

(Synthesis of Polyolefin Wax (III))

Into a stainless steel autoclave having an internal volume of 2 L and purged sufficiently with nitrogen were charged 930 mL of hexane and 70 mL of 1-butene. Hydrogen was introduced into the autoclave until the pressure thereof reached 20.0 kg/cm² (gauge pressure). Next, the temperature in the system was raised to 170° C. Thereafter, polymerization was started by pressuring 0.1 mmol of triethylaluminum, 0.4 mmol of ethylaluminum sesquichloride, and 0.008 mmol of the catalyst obtained as described above, this amount being converted to titanium atoms, into the system with ethylene. Thereafter, the total pressure therein was kept at 40 kg/cm² by continuous supply of only ethylene, so as to continue the polymerization at 170° C. for 40 minutes. The polymerization was stopped by adding a small amount of ethanol to the system, and then unreacted ethylene and 1-butene were purged. The resultant polymer solution was dried overnight at 100° C. under a reduced pressure. Physical properties of the resultant wax were measured. As a result, the following values were obtained:
molecular weight (GPC): Mn=2000, and Mn=6800,
molecular weight distribution (GPC): Mw/Mn=3.4,
density: 917 kg/m³, melting point (according to the DSC method): 106° C., softening point: 111° C., and penetration: 8 dmm.

### Example 1

(Preparation of Solution for Forming Thermal Transfer Ink Layer)

The following were melted and mixed to prepare a solution for forming thermal transfer ink layer: 20 parts by weight of the polyolefin wax (I), 30 parts by weight of carnauba wax, 35 by weight of an ethylene/vinyl acetate copolymer (trade name: V-577-2, manufactured by DUPONT-MITSUI POLYCHEMICALS Co., Ltd.), and 15 parts by weight of carbon black.

(Production of Thermal Transfer Recording Medium)

The above-mentioned solution for forming thermal transfer ink layer was applied onto a support by hot melt coating, so as to give an adhesion amount of 3.0 g/m², thereby yielding a thermal transfer recording medium.

The thus-obtained thermal transfer recording medium was made into a ribbon form. The medium was then traveled on a printer having a thin film type thermal head and used to print images on a fine paper sheet (“KYP” 135 g, manufactured by Nippon Paper Group, Inc.), as an image-receiving body, thermally at a printing energy of 1 mg/dot (4×10⁴ cm²). Background stains thereof were evaluated with the naked eye. The medium on which the images were thermally formed was used to make an abrasion resistance test. The results are shown in Table 1.

### Example 2

A thermal transfer recording medium was yielded in the same way as in Example 1 except that the polyolefin wax (II) was used instead of the polyolefin wax (I). The resultant thermal transfer recording medium was used to make an evaluation about background stains and make an abrasion resistance test in the same way as in Example 1. The results are shown in Table 1.

### Example 3

A thermal transfer recording medium was yielded in the same way as in Example 1 except that the amount of the polyolefin wax (I) and that of the carnauba were changed to 50 parts by weight and 0 parts by weight, respectively. The resultant thermal transfer recording medium was used to carry out thermal recording and then make an evaluation about background stains and an abrasion resistance test in the same way as in Example 1. The results are shown in Table 1.

### Example 4

(Preparation of Solution for Forming Thermal Transfer Releasing Layer)

The following were melted and mixed to prepare a solution for forming thermal transfer releasing layer: 95 parts by weight of the polyolefin wax (I), and 5 parts by weight of a styrene/butadiene copolymer and an ethylene/vinyl acetate copolymer (trade name: EV-210, manufactured by DU PONT-MITSUI POLYCHEMICALS Co., Ltd.).

(Preparation of Solution for Forming Thermal Transfer Ink Layer)

The following were melted and mixed to prepare a solution for forming thermal transfer ink layer: 40 parts by weight of the polyolefin wax (I), 20 parts by weight of paraffin wax (trade name: HNP-10, manufactured by NIPPON SEIRO CO., LTD, Inc.), 125 parts by weight of an ethylene/vinyl acetate copolymer (trade name: EV-40Y, manufactured by DU PONT-MITSUI POLYCHEMICALS Co., Ltd.), and 15 parts by weight of carbon black.

(Production of Thermal Transfer Recording Medium)

The above-mentioned solution for forming thermal transfer releasing layer was applied onto a support by hot melt coating, so as to give an adhesion amount of 1.5 g/m² after the solution was dried, thereby forming a releasing layer. Next, the above-mentioned solution for forming thermal transfer ink layer was applied onto the releasing layer by hot melt coating, so as to give an adhesion amount of 3.0 g/m², thereby yielding a thermal transfer recording medium. The resultant thermal transfer recording medium was used to carry out thermal recording and then make an evaluation about background stains and an abrasion resistance test in the same way as in Example 1. The results are shown in Table 1.

### Comparative Example 1

A thermal transfer recording medium was yielded in the same way as in Example 1 except that the polyolefin wax (III) was used instead of the polyolefin wax (I). The resultant thermal transfer recording medium was used to carry out thermal recording and then make an evaluation about background stains and an abrasion resistance test in the same way as in Example 1. The results are shown in Table 1.

TABLE 1

| Evaluation | Exam- | Exam- | Exam- | Exam- | Comparative |
|---|---|---|---|---|---|
| items | ple 1 | ple 2 | ple 3 | ple 4 | Example 1 |
| Abrasion | Good | Good | Good | Good | Allowable |
| resistance | | | | | |
| Background | Good | Good | Good | Good | Poor |
| stains | | | | | |

Abrasion resistance:

Good: No omissions were found in images.

Allowable: Small omissions were found in images.

Poor: Considerable omissions were found in images.

Background stains:

Good: No stains were observed.

Allowable: A slight amount of stains was observed.

Poor: Stains were observed.

In the abrasion resistance test, an unused paper sheet was put on each of the sheets on which the images were thermally printed, and then a load of 500 g was put thereon. Subsequently, each of the resultant samples was fitted to a JSPS (Japan Society for the Promotion of Science) type abrasion resistance tester, model II (manufactured by TESTER SANGYO CO,. LTD.), and then rubbed 100 times. The abrasion resistance thereof was evaluated on the basis of the printed-image state.

### INDUSTRIAL APPLICABILITY

The thermal transfer recording medium according to the present invention makes it possible to give printed images superior in sharpness and abrasion resistance, without generating any background stain, at a low energy. Thus, the thermal transfer recording medium is useful.

1. A thermal transfer recording medium, comprising a support and a thermally-melting layer formed on or over the support, wherein the thermally-melting layer comprises a polyolefin wax defined in the following items (i) to (iv):
(i) the wax comprises an ethylene homopolymer or a copolymer made from ethylene and an α-olefin having 3 to 10 carbon atoms,
(ii) the wax has a number-average molecular weight (Mn) of 400 to 3,000, the molecular weight being measured by gel permeation chromatography (GPC),
(iii) the wax has a melting point of 60 to 120° C., the melting point being measured with a differential scanning calorimeter (DSC), and
(iv) the softening point (Ts (° C.)) of the wax and the penetration (Y (dmm)) thereof satisfy the following relationship expression (I):
Y≦−0.220×Ts+32.0 (I)

2. The thermal transfer recording medium according to claim 1, wherein the ratio of the weight-average molecular weight (Mw) of the polyolefin wax to the number-average molecular weight (Mn) thereof is 3.2 or less.

3. The thermal transfer recording medium according to claim 1, wherein the density of the polyolefin wax is from 880 to 950 kg/m³, the density being measured by density-gradient tube method.

4. The thermal transfer recording medium according to claim 1, wherein the polyolefin wax is a modified polyolefin wax which is subjected to oxidization modification or acid-graft modification.

5. The thermal transfer recording medium according to claim 1, wherein the polyolefin wax is a hompolymer or copolymer produced by use of a metallocene catalyst.

6. The thermal transfer recording medium according to claim 1, wherein the thermally-melting layer comprises a colorant.

7. The thermal transfer recording medium according to claim 1, wherein a thermally-melting ink layer comprising a colorant and a thermally-melting material is formed on or over the thermally-melting layer.

8. A thermal transfer recording medium comprising a support and a thermally-melting layer formed on or over the support, wherein the thermally-melting layer comprises a polyolefin wax having a number-average molecular weight (Mn) of 400 to 3,000, the molecular weight being measured by gel permeation chromatography (GPC), an Mw/Mn (Mw: weight-average molecular weight) of 3.2 or less, a density of 880 to 950 kg/m³, the density being measured by density-gradient tube method, and a melting point of 60 to 120° C., the melting point being measured with a differential scanning calorimeter (DSC).
